(19) United States
(12) Patent Application Publication
(10) Pub. No.: US 2007/0238474 A1
(43) Pub. Date: Oct. 11, 2007

(54) Instant text reply for mobile telephony devices

(76) Inventors: Paul Ballas, Oak Hill, VA (US); Stanley Ballas, Oak Hill, VA (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/708,220

(22) Filed: Feb. 20, 2007

Related U.S. Application Data
(60) Provisional application No. 60/789,660, filed on Apr. 6, 2006.

(51) Int. Cl. H04Q 7/20

(52) U.S. Cl. 455/466

(57) ABSTRACT

A cellphone program or service is disclosed to allow a user to set up an instant text reply for both incoming voice calls and SMS messages from other cellphone users via an SMS message (hereinafter, Instant Text Reply) stating the reason for the user's unavailability. In use, a cellphone user can create, save, and select various outgoing SMS messages from their cellphone user interface. The cellphone user then selects the desired instant text reply message that will be automatically sent to other cellphone users attempting to contact them for a predetermined time period. At the end of the time period for operation of the Instant Text Reply, the operation of the cellphone is returned to its ordinary function. The invention can be implemented with a program on the cellphone or at the carrier level. When used in combination with a carrier program, the cellphone user can optionally turn off their cellphone.

This application claims priority to U.S. Provisional Application Ser. No. 60/789,660, filed Apr. 6, 2006, which is incorporated herein by reference in its entirety for all purposes.

### BACKGROUND OF THE INVENTION

Cellular phones, smart phones and other mobile telephony devices (hereinafter, cellphones) are becoming more and more prevalent, even to the point of replacing “land line” telephones for many users. Services that are commonly available on such mobile telephony devices include voicemail, for providing a standard greeting and recording a message when the device is off or not answered, and Short Message Service (SMS), for sending and receiving short text messages to other mobile telephony users.

SMS is a text message service that enables short messages of generally no more than 140-160 characters in length to be sent and transmitted from a mobile telephony device such as a cellphone. SMS was introduced in the GSM system and later supported by all other digital-based mobile communications systems. SMS messages travel to the cellphone over the system's control channel, which is separate and apart from the voice channel. The use of SMS, or “texting” as it is commonly referred to, is very popular with young cellphone users and is often used in a manner similar to instant messaging services available on the Internet.

For the majority of cellphone users, the only option for notifying callers that the cellphone user is unavailable is the voicemail service provided by the carrier. No options are typically available for notifying those who send SMS messages that the cellphone user is unavailable to respond to the text message.

Various attempts have been made to address each of these issues. For example, two programs have been developed for Pocket PC-based phones to automatically send an SMS message in response to voice calls from other cellphone users. SMS Answering Machine from Boo! Interactive sends customized SMS messages to these callers when the user of the Pocket PC-based phone cannot answer the call. The other program, Please Do Not Disturb from JGUI, is simpler and sends out a single, customizable SMS message to all callers or callers from the Pocket PC's Contacts list when activated. Neither of these programs handles incoming SMS messages and neither is available for ordinary (i.e., non-Pocket PC-based) cellphone users.

Recently, Comverse, a unit of Comverse Technology, Inc., announced the availability of SMS Personal, a package of services that increases personalization of SMS text messaging. One of the services in the package is SMS Auto-Reply, wherein an automatic SMS reply is sent to senders of SMS messages. Comverse states that this feature brings email “out-of-office” automatic response functionality to SMS. However, SMS Auto-Reply does not handle incoming voice calls and is not available separate from Comverse's package of services.

What would be useful is a single means to respond for a predetermined time period to both voice calls and SMS messages from other cellphone users with an SMS message stating the reason for the user's unavailability.

### BRIEF SUMMARY OF THE INVENTION

The present invention provides a cellphone program or service to allow a user to set up an instant text reply for both incoming voice calls and SMS messages from other cellphone users via an SMS message (hereinafter, Instant Text Reply) stating the reason for the user's unavailability. In use, a cellphone user can create, save, and select various outgoing SMS messages from their cellphone user interface. The cellphone user then selects the desired instant text reply message that will be automatically sent to other cellphone users attempting to contact them for a predetermined time period. At the end of the time period for operation of the Instant Text Reply, the operation of the cellphone is returned to its ordinary function. The invention can be implemented with a program on the cellphone or with a combination of an interface or program on the cellphone and a program at the carrier level. When used in combination with a carrier program, the cellphone user can optionally turn off their cellphone.

One aspect of the invention is to provide cellphone users with more options when they will be unable to answer their phone for various reasons.

Another aspect of the invention is to provide a single means to respond to both voice calls from other mobile telephony devices and SMS messages when a user is unable to answer their phone.

Yet another aspect of the invention is to have the cellphone return to ordinary operation after a predetermined period of time.

A further aspect of the invention is to provide cellphone users with an easy way to specify a specific reason why they are unavailable so as to provide additional information to callers.

An additional aspect of the invention is to provide callers with an instant reply so that they don't have to wait for the time needed to leave a voice mail or for a return SMS.

### BRIEF DESCRIPTION OF THE DRAWINGS

FIG. 1 illustrates one embodiment of a graphic user interface in accordance with the present invention;

FIGS. 2A and 2B illustrate two embodiments of a graphic user interface for time period selection in accordance with the present invention;

FIG. 3 illustrates an embodiment of a graphic user interface for system settings in accordance with the present invention;

FIG. 4 illustrates an embodiment of a graphic user interface for message selection or creation in accordance with the present invention;

FIG. 5 illustrates an embodiment of a graphic user interface for creating a new message in accordance with the present invention;

FIG. 6 illustrates an embodiment of a graphic user interface for instant text message confirmation in accordance with the present invention;

FIG. 7 illustrates an embodiment of a graphic user interface for an instant text message program in accordance with the present invention; and

FIG. 8 illustrates an alternate embodiment of a graphic user interface for an instant text message program in accordance with the present invention.

### DETAILED DESCRIPTION OF THE INVENTION

As used herein, the term “cellphone” refers to any mobile telephony device that has an interface capable of sending and receiving mobile telephone calls and text or other user-created messages via SMS, and/or as adoption increases, MMS (multimedia messaging service), including, but not limited to, mobile telephones, Pocket-PC devices, Palm-OS devices, Windows Mobile Smartphones, Palm® Treo™ smartphones, HP iPAQ mobile messenger devices, Apple iPhones, etc.

In one embodiment of the present invention, a program is installed on a user's cellphone. The program is accessed through the main menu of the cellphone using the existing interface controls (e.g., menu button, scroll buttons, touchscreen icons, keypad, etc.). Optionally, the program can be accessed through entry of a “hot key” combination (e.g., *47) on a keypad of the cellphone or a dedicated key or button on the cellphone interface.

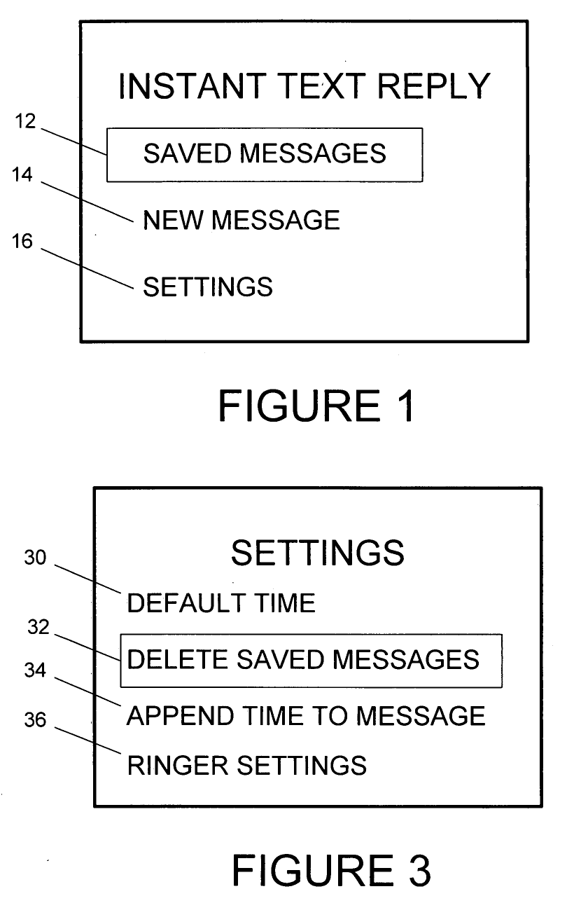

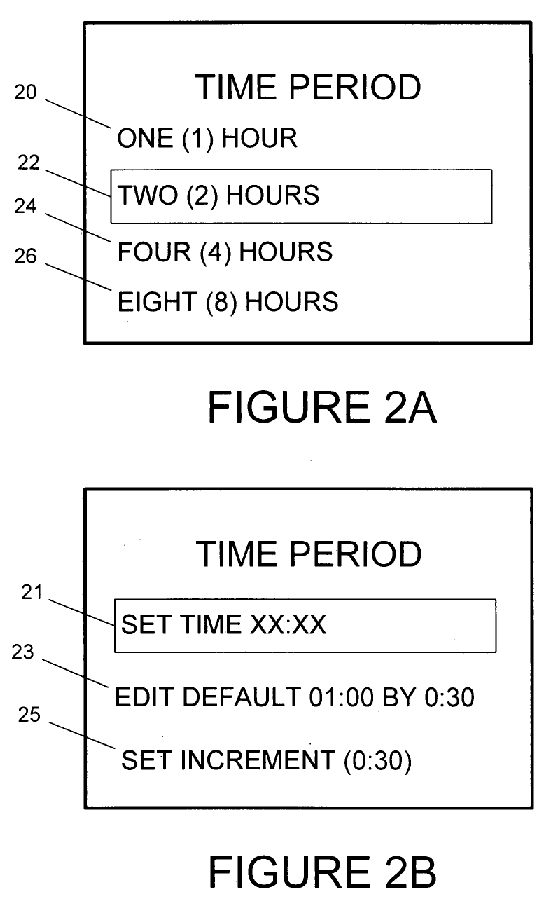

As illustrated in FIG. 1, upon accessing the program, a user is presented with options to choose a desired outgoing SMS message from a list of previously-stored messages by selecting SAVED MESSAGES 12, to create a new message by selecting NEW MESSAGE 14, or, optionally, to edit program settings by selecting SETTINGS 16. While it can be desirable to have a portion of the program that is used to edit default settings, such as a default time period for newly-created messages or a default time increment for changing the time setting, the option to provide this is not critical to the invention since standard defaults can be built into the program and various means can be implemented for altering the default time. However, in one embodiment of the invention, as illustrated in FIGS. 2A, 2B and 3, a user is provided with a menu option to edit system settings and then chooses a default time period 30, such as from a list 20, 22, 24, 26, as shown in FIG. 2A or by inputting a numerical value 21, as shown in FIG. 2B. The user can also set a default increment 25 that can be used with up/down keys or other designated controls to allow editing of the default time period 23 in a desired increment, such as 0:15, 0:30, 1:00, etc. As illustrated in FIG. 3, other options that can be included in the edit settings are: an option to delete selected previously-stored messages 32, an option to include time information in the text message 34, such as appending “until XX:XX EDT” where XX:XX is the time that the predetermined time period for sending the message will end, or an option to disable the ringer 36 when the Instant Text Reply is in operation.

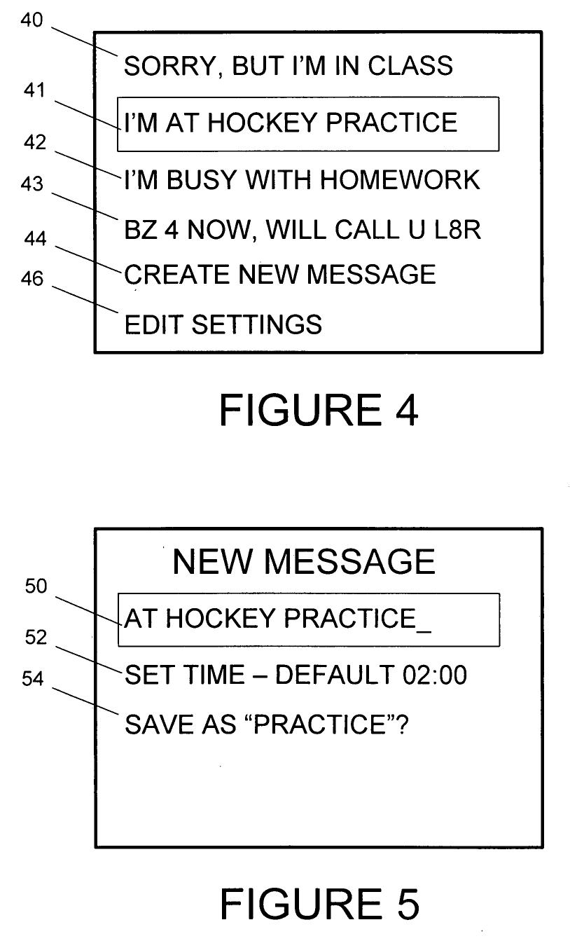

In one embodiment, as illustrated in FIG. 4, the interface will immediately provide a list of available messages 40, 41, 42, 43 to scroll through and provide options to create a new message 44 and change system settings 46 (if included) within the list, typically at the beginning or, as illustrated in FIG. 4, at the end of the listing. In another embodiment, as previously illustrated in FIG. 1, the user is presented with a menu of the three choices: saved messages, create new message, and edit settings.

Upon selecting a menu option to create a new message, the user is prompted to input the desired text message using the existing interface controls, such as a keypad, keyboard, or touchscreen, as illustrated in FIG. 5. After entering the message, such as “out to lunch,” “in class,” “in a meeting,” or “at hockey practice” 50, the user is prompted to set the predetermined time period 52 that the message will be sent before the cellphone returns to its default operation. Whether or not a system settings option is provided, a default time period can be 1:00, which can be increased or decreased in 0:30 increments using appropriate interface controls such as up/down selection buttons used to scroll menus. After the time period has been selected, such as by selecting an “OK” button on the cellphone's interface controls, the user is prompted to save the message 54 with an appropriate name for later use. While it is possible that a user will not want to save the message for later use, failure to save the message means that the user will not have it available for later use.

If the user chooses to save the message, they are prompted for a short name for later selecting the message from the listing. In one embodiment, the longest word in the text message is set as the default name that can still be edited by the user. As such, the prior example text messages “out to lunch” defaults to “lunch,” “in class” defaults to “class,” “in a meeting” defaults to “meeting,” and “at hockey practice” defaults to “practice” as illustrated at 54

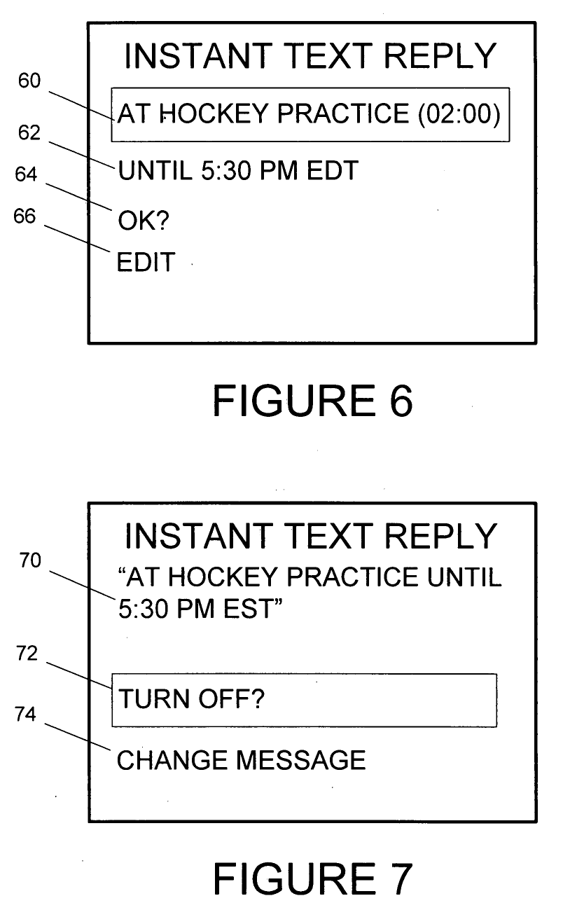

Upon selecting a menu option to use a previously-saved message or upon opening the program and being presented with a full listing of previously saved messages, a user selects the short name of the saved message from a list, typically by scrolling and selecting the message name using the interface controls of the cellphone. Upon selection, the full text of the message 60 is displayed along with the default time setting and any other selected options such as an appended “until XX:XX EDT” setting 62, as illustrated in FIG. 6. The user can then make any changes they want by selecting to edit 66 and/or confirm 64 the message they want to have sent for the predetermined time period. If changes have been made, the user can be given the option to save the changes.

When in use, the first option presented to the user upon selecting or accessing the program from the cellphone, as illustrated in FIG. 7, is whether they want to turn off 72 or change 74 the present message 70. Optionally, a hot key combination can be used to either access the program or instantly disable the present message and return the cellphone to default operation. In another embodiment, simply opening the phone or pressing any key will prompt the user as to whether they want to turn off or change the present message.

During operation of the invention, the ringer on the phone will typically be disabled (although this can be a user-selectable option) as will any SMS notification sounds. These features are desirable for those in business meetings and such who may want to access their cellphone for other reasons, but do not want the cellphone to interrupt them. When a voice call is received from another SMS-capable device (i.e., another mobile telephony device), the call will be immediately disconnected and the Instant Text Reply is sent back to the caller over the system's control channel via SMS service. In this manner, the caller will be informed of the reason for the cellphone user's unavailability without having to wait for the optional voicemail message. If additional information is sent, such as by having an “until XX:XX EDT” appended to the Instant Text Reply, the caller is further informed as to when they can call again to reach the cellphone user.

Similarly, when an SMS message is sent to the cellphone user from another SMS-capable device (i.e., another mobile telephony device), the Instant Text Reply is sent back to the SMS-message sender (“texter”) over the system's control channel via SMS service. In this manner, the texter will be informed of the reason for the cellphone user's unavailability without having to wait for the cellphone user to receive and personally respond to the SMS message. If additional information is sent, such as by having an “until XX:XX EDT” appended to the Instant Text Reply, the texter is further informed as to when they can again reach the cellphone user, whether by phone call or SMS.

In an alternate embodiment that involves the carrier, upon selecting a message or disabling a message, the appropriate information is sent by the Instant Text Reply application program on the user's cellphone using the system's control channel so the Instant Text Reply function can be implemented at the carrier level (as done by voicemail) and the cellphone user can turn off their cellphone.

In another embodiment, when the Instant Text Reply program is opened up, it presents several options to select. One option is “New Message.” When this option is selected, the user has the ability to type in their message, and the option to save this message for later use. The second option on the main program screen is “Saved Messages” and shows the user a list of previously saved messages which can selected and displayed. When a “Reply Message” is typed in or accessed through one of the previously saved messages, the next option presented to the user on the cellphone is a screen asking “Would you like this text to reply to any incoming cell phone calls and/or texts?” . . . “Yes or No.” When the user chooses “Yes,” the cellphone closes out of the program and an icon is displayed on the main screen of the user's cellphone. In one embodiment, the icon can be an ITR logo indicating that the Instant Text Reply is in operation. When anyone on an SMS-capable cellphone calls the user or texts the user, the message they chose to reply with will automatically be texted back to the caller or texter.

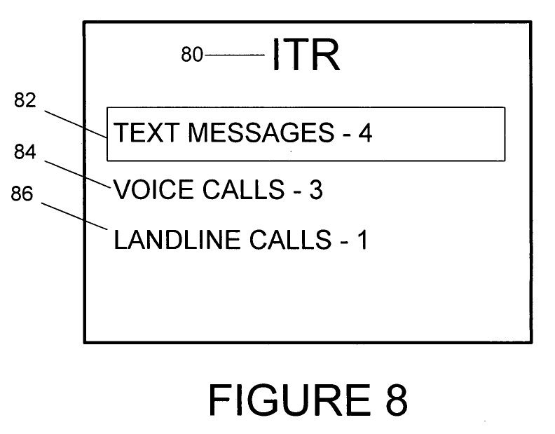

In one embodiment, the text message that will be displayed will say, “ITR: (message they choose to display).” The “ITR” initials before the text will allow the receiver of the text to know that the person they are trying to reach is away at the time being and this is the automatic reply they chose to send out for anyone trying to reach them. Other possible indicators that could be appended to the Instant Text Reply include “Auto-reply” or “User not available.” When the user of the present invention looks at their cellphone, it can preferably show, as illustrated in FIG. 8, the ITR icon 80 and how many incoming calls 84, 86 and texts 82 have occurred. The user will then have the option to view incoming cell phone calls, texts, and landline phone calls that did not receive the Instant Text Reply due to not being SMS-capable. Once the user of the present invention does not desire to send out the Instant Text Reply anymore, there is an option, accessed through the program, to select the option “Here!”

Once the user has selected this option it will no longer send out the Instant Text Reply message. As mentioned above, the Instant Text Reply of the present invention is only available through the use of SMS-capable cellphones. If a person using a landline telephone calls a person on a cell phone and they have the Instant Text Reply in operation, then the person using the landline telephone will be directed to the user's voicemail in the usual manner as if the cellphone was turned off.

As is often the case consumer electronic devices, the ease of use and interface design can be critical to adoption by users, such as in the case of Apple's iPod® music players. To allow easy adoption of the invention by users, it may be desirable to provide a simple interface embodiment of the present invention. Such an embodiment would preferably provide easy access to core capabilities of the invention. A hot key combination, such as “###”, or a dedicated “ITR” button would activate or deactivate the ITR function, i.e., toggle the auto-reply function on or off. A default message, such as “Auto-Reply: I'm not available” would be invoked when in operation. In one particular embodiment, an option to edit the message can be included. If the option to edit the message is provided, “new” replies are automatically saved when an existing reply is edited. In such an embodiment, the only choices are selecting a reply and setting it or editing and setting it. Names for each reply would be automatically generated based on longest word, with the addition of sequential numbers to those having the same longest word. Upon activating the ITR, the default message is set and the user is given a short period of time to scroll to another message or choose to edit an existing message. Defaults times and options in such an embodiment could be set during program installation.

A system and method for providing an Instant Text Reply to voice calls and SMS messages have been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the it to the singular.

What is claimed is:

1. A method for automatically responding to mobile telephony calls and text messages, comprising:
a cellphone user activating an auto-reply message;
responding to both mobile telephony calls and text messages directed to the cellphone with the auto-reply message for a predetermined period of time; and
returning the cellphone to a default operation upon expiration of the predetermined time or upon user deactivation of the auto-reply message.

2. The method of claim 1, wherein the cellphone user activates the auto-reply message using software and an interface on the cellphone.

3. The method of claim 2, wherein responding is selected from the group consisting of software on the cellphone operating to send the auto-reply message and the cellphone carrier sending the auto-reply message.

4. The method of claim 2, wherein the software and interface on the cellphone are further used to create and save new auto-reply messages.

5. The method of claim 4, wherein activating an auto-reply message further comprises selecting the auto-reply message from a list of saved auto-reply messages.

6. The method of claim 2, wherein the software and interface on the cellphone are further used to select the predetermined period of time.

7. The method of claim 2, wherein user activation and deactivation of the auto-reply message is accomplished using a hot key combination.

8. A system for automatically responding to mobile telephony calls and text messages, comprising:
a user cellphone
means on the user cellphone for activating an auto-reply message;
means for responding to both mobile telephony calls and text messages directed to the cellphone with the auto-reply message for a predetermined period of time; and
means for returning the cellphone to a default operation upon expiration of the predetermined time or upon user deactivation of the auto-reply message.

9. The system of claim 8, wherein the means on the user cellphone for activating an auto-reply message is software instructions on the user cellphone and an interface on the user cellphone.

10. The system of claim 9, wherein the means for responding is selected from the group consisting of software on the cellphone operating to send the auto-reply message and a cellphone carrier sending the auto-reply message.

11. The system of claim 9, wherein the software instructions and interface on the cellphone provide means to create and save new auto-reply messages.

12. The system of claim 11, wherein the software instructions and interface on the cellphone further comprises means for selecting the auto-reply message from a list of saved auto-reply messages.

13. The system of claim 9, wherein the software instructions and interface on the cellphone are further used to select the predetermined period of time.

14. The system of claim 9, wherein the software instructions and interface on the cellphone provide a hot key combination for activation and deactivation of the auto-reply message.
